(19) United States
(12) Patent Application Publication
(10) Pub. No.: US 2014/0089201 A1
(43) Pub. Date: Mar. 27, 2014

(54) Modular and embeddable electronic commerce system

(71) Applicants: Aleks Jakulin, Brooklyn, NY (US); Damir Zekie, Sarajevo (BA); John Joseph Bachir, New York, NY (US); Mirza Sadovic, Sarajevo (BA)

(72) Inventors: Aleks Jakulin, Brooklyn, NY (US); Damir Zekie, Sarajevo (BA); John Joseph Bachir, New York, NY (US); Mirza Sadovic, Sarajevo (BA)

(21) Appl. No.: 13/624,292

(22) Filed: Sep. 21, 2012

(51) Int. Cl. G06Q 20/00

(52) U.S. Cl. 705/64

(57) ABSTRACT

A system and method that provides trusted commerce functionality on an untrusted website is disclosed. Content rights owners upload the content to the system. The system generates a piece of HTML code to be copied and pasted into a website. The code generates a commerce widget. The widget allows a buyer to review the content, its description and its price, and to safely execute the purchase. The widget maintains an authenticated session with the buyer or visitor in a way that requires no registration prior to purchase. Upon purchase, the buyer can access the content from the widget itself, and means of logging in if they have already purchased the content. The owners can offer items for sale on their own web properties without having to operate as merchants and without redirecting their visitors to other websites. The buyers can make changes to their identity without losing their purchases.

### CROSS-REFERENCE TO RELATED APPLICATIONS

This application claims the benefit of PPA Number 61537221, Confirmation Number 1032, filed Sep. 21, 2011, by the present inventors, which is incorporated by reference.

### BACKGROUND

1. Technical Field

The present invention relates to offering media content or services for sale using a system of interconnected software processes.

2. Background Description of Related Art

Assume an author or an owner of digital content that wants to sell his work through his own website. This requires the following functionality:
Taking a payment through a variety of payment mechanisms, and performing accounting.
Associating the payment with the identity of the buyer, without the assumption that the buyer has ever used the system.
Delivering the content to an authorized buyer in accordance with the terms of the sale.
   All of this has to be done quickly with minimum hassle before the prospective buyer loses his interest or trust.

Assuming they are selling content (most typical of offerings), the authors or owners (together, providers) have the following options:
1. Integration with payment systems such as PayPal (U.S. Pat. No. 7,877,299 to Bui), Google (U.S. Pat. No. 7,953,642 to Dierks), or micropayment systems (U.S. Pat. No. 7,596,530 to Glasberg). Providers have to become merchants: they need to create and manage merchant accounts, provide customer support, and handle compliance and taxes directly. Moreover, considerable work is required to ensure that payments are correctly associated with user accounts and that buyers can access their purchases: buyers often get no guarantee of delivery after they have made the payment. This is acceptable for physical goods that get shipped, but is not acceptable for digital goods and services that can be given to buyers instantly. A registration process is usually required to connect the payment with the identity of a buyer, and it can take several minutes for a buyer to create an account. Transactional wrappers such as E-junkie simplify the integration by offering embeddable commerce with a link. They deliver the content after collecting the payment. But they perform no association between the retrieval of the content and a user account, and the buyer needs to manage all his acquired digital assets manually.
2. The owner could place a link from his own website to a media retailer such as iTunes (U.S. Pat. No. 7,797,242 to Gautier), Amazon MP3 (U.S. Pat. No. 7,848,965 to Heyworth). The retailers limit direct communication between the buyer and the provider, the content needs to be presented in standard ways, sold under retailer's terms, and classified in rigid taxonomies. The providers have little control over what other products or services are going to be presented alongside their own content. Providers have limited incentive to promote their content because the percentage of revenue they get is relatively low.
3. Software applications such as iTunes (U.S. Pat. No. 7,797,242 to Gautier), and operating systems such as Apple iOS and Android provide simplified purchasing of digital goods. The downside of this approach is that the buyer needs to install such software or purchase an appropriate device, and the provider needs to accept the format and restrictions of any retailer the buyer might be using. Moreover, the purchases are available only if the buyer continues to use the software or hardware supported by the application or operating system where the purchase was made. This is particularly inconvenient if the buyer has multiple hardware devices.
4. Some newer solutions, like (US 2008/0270909 by Kaufman et al) or Topspin Media, provide embeddable components that allow adding items to a cart without a redirection through a non-interactive component. The buying process is relatively slow, with a second-long delay between clicking “buy” and appearance of a confirmation screen. The buyer isn't able to access the content through the page it was purchased from. Often the content can be accessed through a secret URL that requires no authentication. This allows an unscrupulous buyer to send that URL to others to retrieve the content without paying the owner. Afterward, it is not possible to access purchased content or services from the website where the purchase was made.

What is needed is a system that would allow providers to sell their content and services easily and quickly on the Internet, without requiring the providers to become merchants. What is further needed is a system allowing providers to offer content and services for sale using their existing Internet properties (such as websites, social media profiles, and similar). What is further needed is a system that keeps track of what the buyer already licensed or purchased, so that buyers can retrieve the content and services from the same website where it was purchased. What is further needed is a commerce system that does not require unnecessary information from the buyer and allows a quick and streamlined purchase flow. What is further needed is a commerce system that allows multiple payment mechanisms without placing a burden of maintaining multiple merchant accounts for the content author or owner.

### SUMMARY OF THE INVENTION

In accordance with one embodiment an embeddable electronic commerce system provides the functionalities of purchasing, checkout, registration, logging in, and delivery of digital content or services within a single compact element, or a widget. The widget can be embedded in any web page, and the process is familiar after YouTube has popularized it for video.

Widgets allow a buyer to 1) preview the content 2) examine the description and price 3) mark an item for purchase 4) initiate the checkout process 5) review and edit items to be purchased 6) pick the form of payment 7) after owning a license, access the content 8) link external identity providers to the content, so that the buyer can log in and access the content from another internet browser 9) unlink his identity from the browser when using a different computer. The content is delivered only to an authenticated and authorized buyer.

As buyers make purchases, the system accumulates the provider's royalties. The provider can choose when to transfer the available royalties to his own bank account, but carries the fees associated with the transfer.

### BRIEF DESCRIPTION OF THE DRAWINGS

FIG. 1 illustrates a block diagram of one embodiment of the electronic commerce system.

FIGS. 2A-2D illustrate screen shots of examples showing how embodiments of the system can be integrated into web pages as widgets.

FIG. 3 illustrates an embodiment of the widget having multiple states in the process from initial state to the accessing of content.

FIGS. 4A-4C illustrates an embodiment of the widget in the process of a buyer logging in and logging out.

FIGS. 5A-5B illustrate operation of the system, which does not require a buyer to register.

FIG. 6 illustrates the master iframe architecture for efficient coordination of the widgets with the server.

FIGS. 7A-7C illustrate the architecture for operating in circumstances of blocked 3^{rd} party cookies and reveal more detail about the protocol of communication between the master iframe and the server.

### DETAILED DESCRIPTION

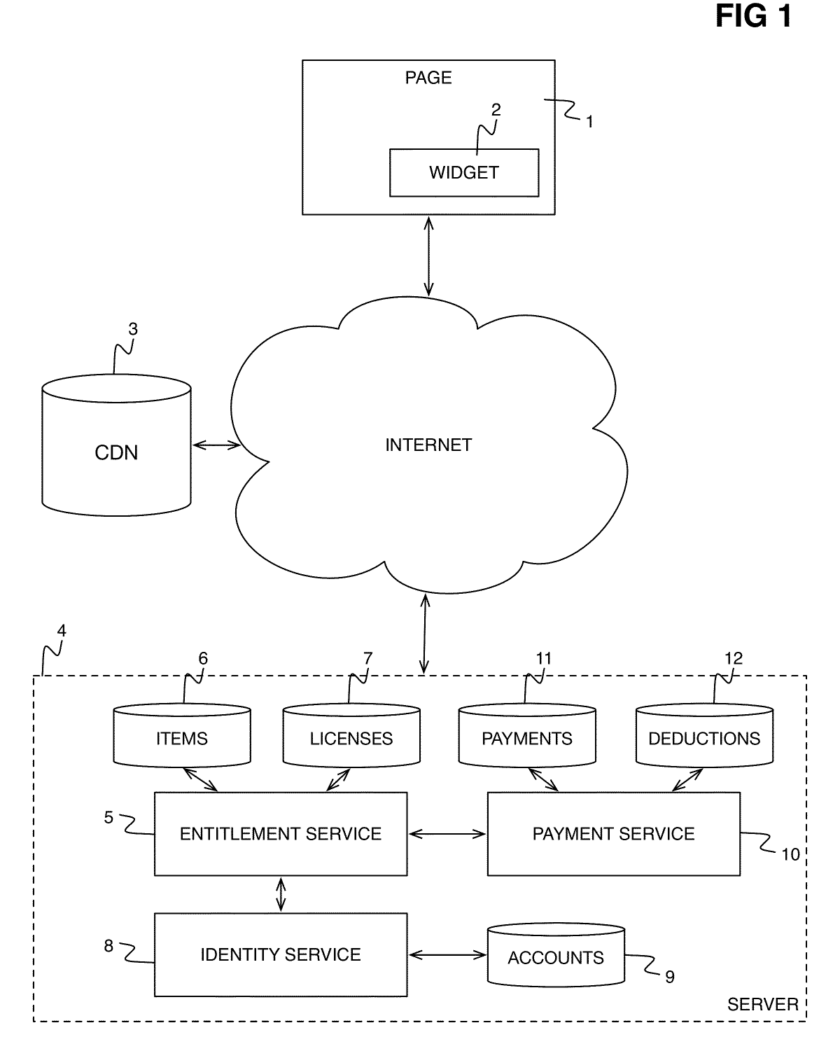

Referring now to FIG. 1, there is a block diagram illustrating one embodiment of the ecommerce system. Page 1 is typically a web page running inside a browser on a network-connected client device operated by a buyer. It can also be an application, a web application, or an interactive document. The widget 2 is an interactive element allowing purchasing, authentication, and delivery of content or services. The widget 2 communicates with the content delivery network (CDN or any other file server) 3 and with the system server 4 through Internet (or some other communication system). The CDN 3 stores the static elements of the widget, such as its code and icons, and the publicly accessible metadata about the content such as images, descriptions or previews. If appropriately configured, CDN 3 can also store the content. In one embodiment, the server system 4 would issue a one-time token to the widget 2 in the browser of an authorized buyer. The token then acts as a key to access the content at the CDN. It's a responsibility of the CDN to deliver the content only to browsers with correct tokens. When watermarking is used, the server system marks the content uniquely for each buyer, so the CDN is not used for delivery.

The server system 4 is composed of multiple web services and databases that allow the transient widget 2 to perform its job. In particular, an entitlement service 5 manages a database of items 6 that are offered for sale, with their prices, metadata, licensing, and purchase terms. The license database 7 stores the buyer's interactions with the items, for example whether a buyer has interacted with the item, added it to a cart, purchased it, or already retrieved it. Entitlement service 5 then informs the widgets about the buyers' state regarding an individual piece of content or service, and coordinates between multiple widgets or interfaces referring to the same piece of content. The entitlement service also propagates price reductions when multiple items are a part of a bundle of items. In essence, the entitlement service 5 is an authorization service: it authorizes the widget to access content.

The identity service 8 manages direct interactions between the server and the buyer, including authentication. The identity service is an authentication service—it authenticates the buyer through a variety of accounts the buyer might have (non-validated email, validated email, telephone number, or federated third-party identities such as OAuth, Facebook Connect, or OpenID). The accounts are stored in a database 9. Identity service 8 also handles direct interfaces with the buyer, such as creation of login popups, password recovery, guest account creation, and similar.

Payment service 10 manages interactions involving the buyer and external payment services, as well as maintaining buyer's and provider's account balance and a transaction log. The database of payments 11 keeps a log of payments from buyers to the system. The database of deductions 12 logs expenses, such as payments to providers and infrastructure costs. The payment service 10 is able to communicate with the entitlement service 5—updating items' states to a “purchased” or “licensed” state after the payment has been received.

Server 4 also offers interfaces for performing checkouts, payments, and analytics. It operates administrative services intended for providers to configure content and services for sale. Server 4 also allows administration of services and configuration of new providers. Server 4 is operated on one or several computers in multiple locations, and includes a variety of other services, including email, web server, analytics, diagnostics, support, and all other features familiar to those of skill in the art.

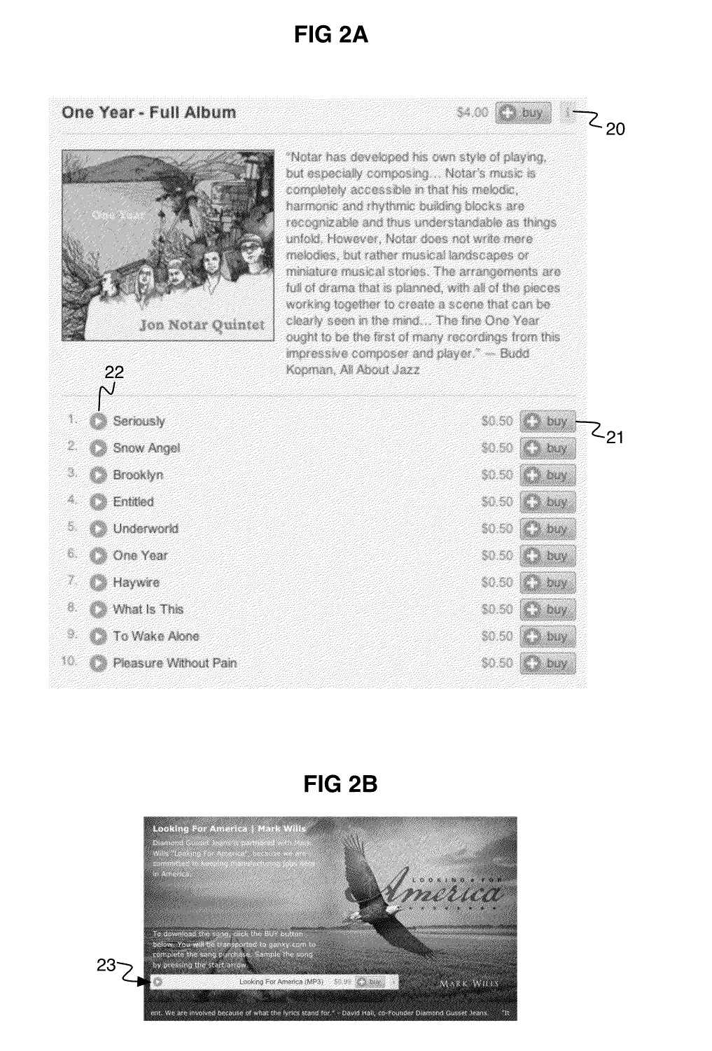

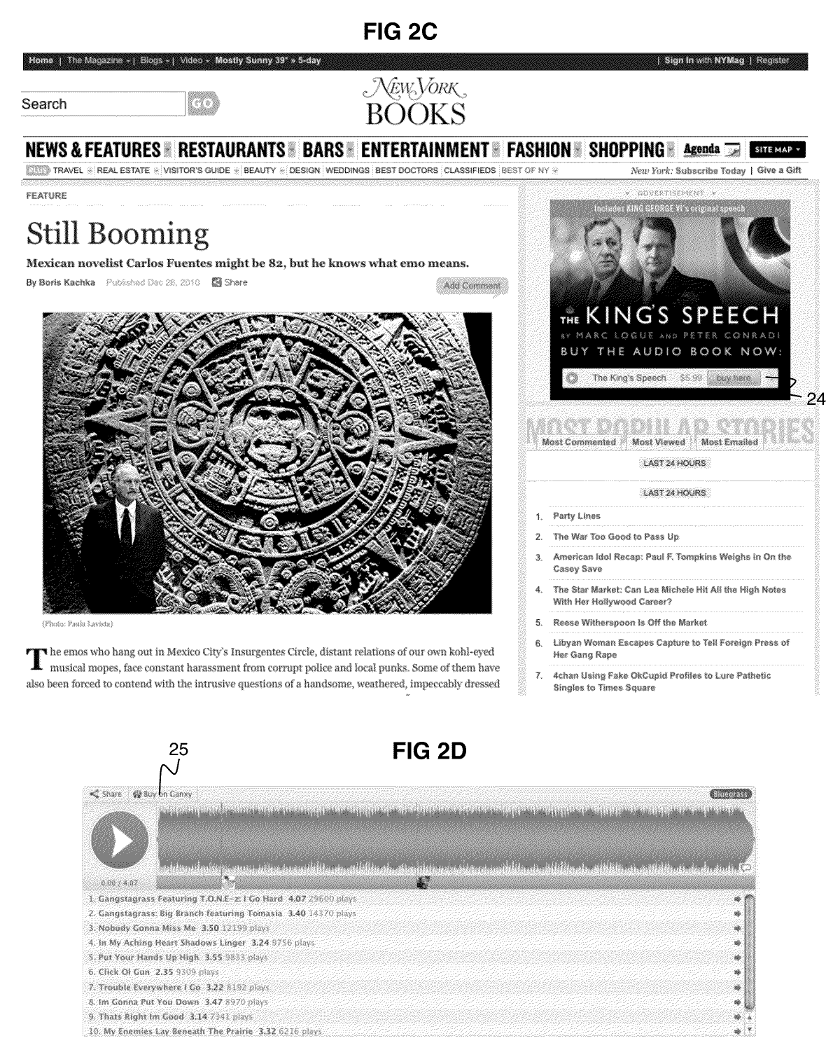

Referring now to several examples of widget embodiments in FIGS. 2A-2D. FIG. 2A illustrates a group of widgets intended for sale of digital downloads of music. There is the widget for selling the complete album 20, which has a button allowing buyers to log in and obtain help. The other widgets 21 instead have a preview button allowing buyers to listen to a sample of the song before purchase by pressing the play button 22. In our system, these widgets communicate with one another so that when a buyer is listening to one sample, clicking play on another will stop the first sample and start the new one. FIG. 2B illustrates that widgets can be inserted into other graphic elements. In this example, the widget 23 appears inside the album art for a music single. FIG. 2C illustrates that widgets can also appear within any other page, such as inside advertisements 24. FIG. 2D illustrates that the functionality of the present system can also appear within other widgets. In this example clicking on the button 25 will lead directly to either checkout or download, depending on the buyer's entitlement.

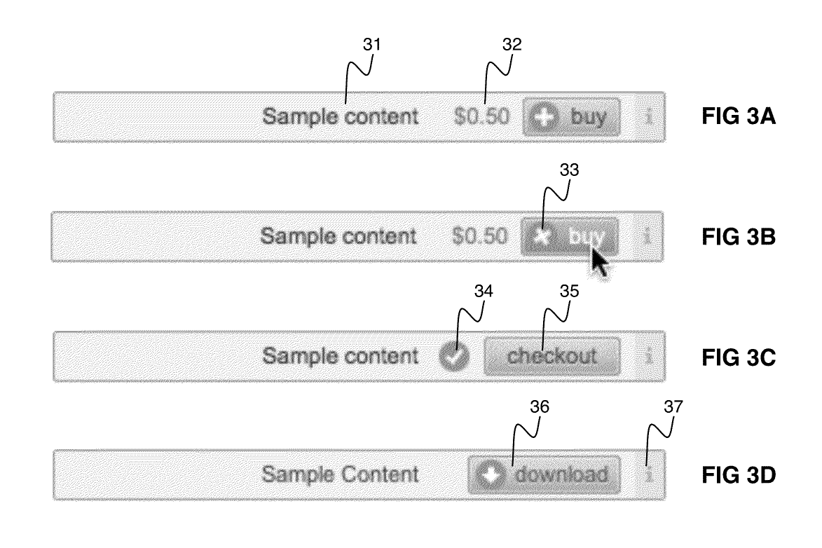

Referring now to FIGS. 3A-3D. They illustrate different states of the widget that depend on the entitlement. In FIG. 3A the widget is shown in the “viewed” state: meaning that the buyer has seen it, but not interacted with it. The title 31 shows the description of the content, minimizing the likelihood of a buyer misinterpreting what is being bought because of an unclear layout of the page. Similarly, the price 32 shows a standard description of the price—with the option to adapt the currency to the location of the purchase and local taxes. Moreover, the price can dynamically change as discounts get applied, as described earlier in the example of bundles.

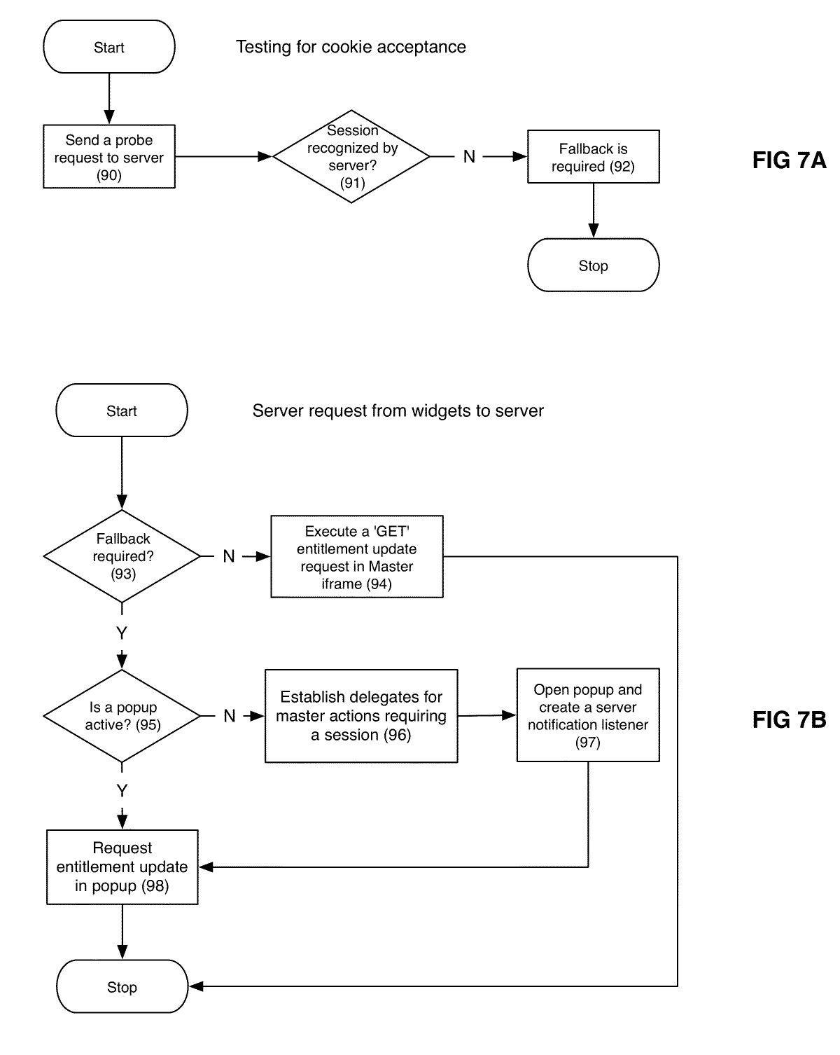

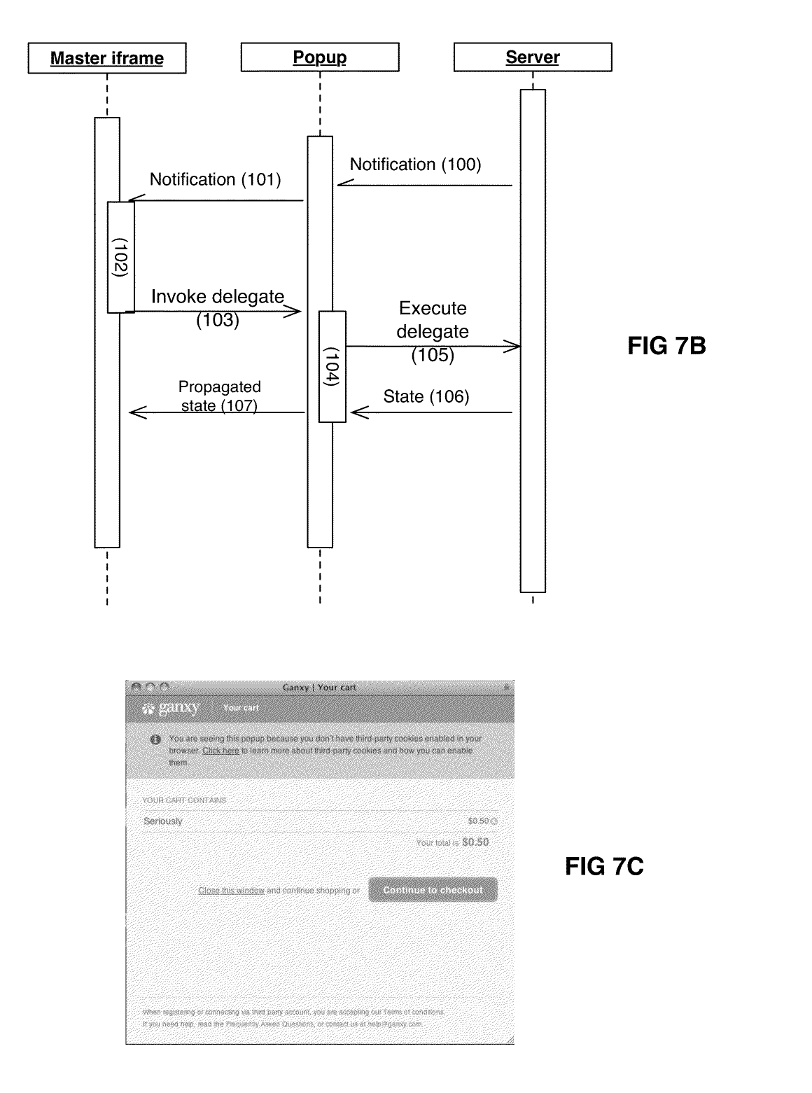

FIG. 3B depicts the widget immediately after the buyer has clicked the “buy” button in the widget. The spinning icon 33 indicates that the widget is in a pending state, whereby the server 4 has not yet confirmed that the item has been added to the cart. This way the buyer knows that his action has been received and is being processed, but he can do other things in the meantime. When the server 4 notifies the widget about the new state, the widget can be rendered in the form depicted in FIG. 3C: the price is no longer interesting and is removed. The check symbol 34 provides an intuitive way of removing the item from the “cart” by un-checking, upon which the state in 3C reverts to state in 3A. Pressing the checkout button 35 opens a new browser page in which the transaction can be completed securely: fully independently from the untrusted website hosting the widget, and allowing the buyer to review all items that are being purchased along with their prices. The checkout display is similar to FIG. 7C but with payment options being listed.

In another embodiment, clicking on “buy” would immediately trigger a purchase or open a payment confirmation page. In yet another embodiment, different payment options would be listed as separate “buy” buttons. After completing the purchase, the server 4 notifies the widget and the widget switches to the mode of FIG. 3D, allowing the buyer to access the content by pressing the “download” button in 36.

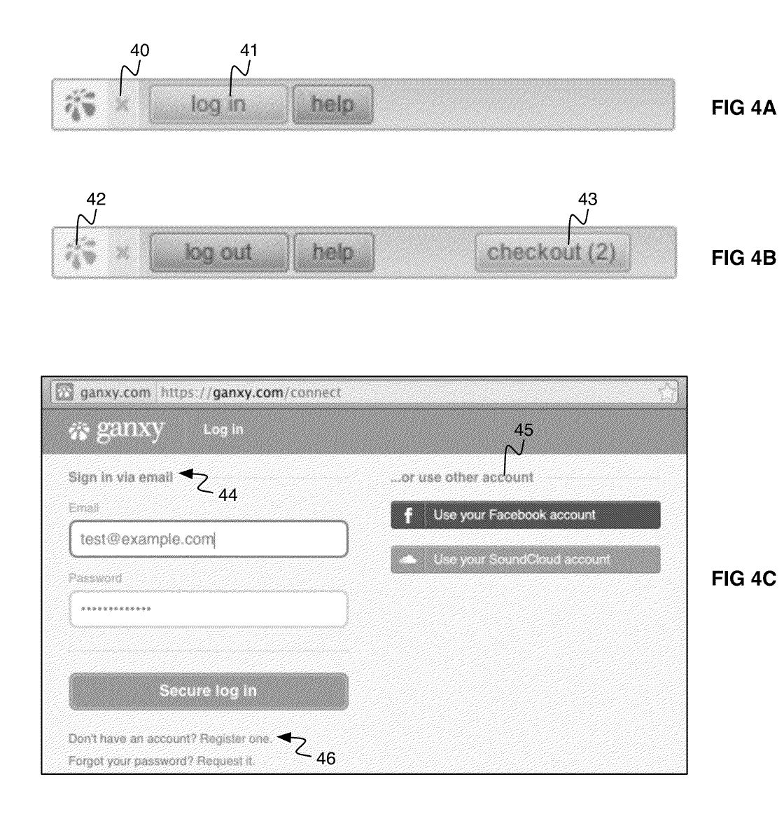

The “info” button 37 opens up the secondary panel with some additional options illustrated in FIGS. 4A-4C. In FIG. 4A, pressing the “close” button 40 will close the secondary panel and return to the state of FIG. 3D. On the other hand, pressing the “log in” button 41 will attempt to authenticate the buyer. The grey buttons light up when the mouse is hovered over them. For example, in FIG. 4B, pressing the “logo” button 42 will invoke information about the system, and pressing the “checkout” button 43 will lead to checkout.

Authentication can sometimes be performed with minimal buyer interaction when federated authentication systems are used, and at this point those with skill in the art will understand these techniques. But in case a federated authentication cannot be performed, FIG. 4C shows an embodiment of the dialog. The dialog opens in a separate window using a secure protocol to allow secure entry of passwords and usernames. The username and password model are offered near 44, but it's frequently easier to authenticate using third-party authentication systems listed near 45. Near 46 there are options for recovery of initial registration.

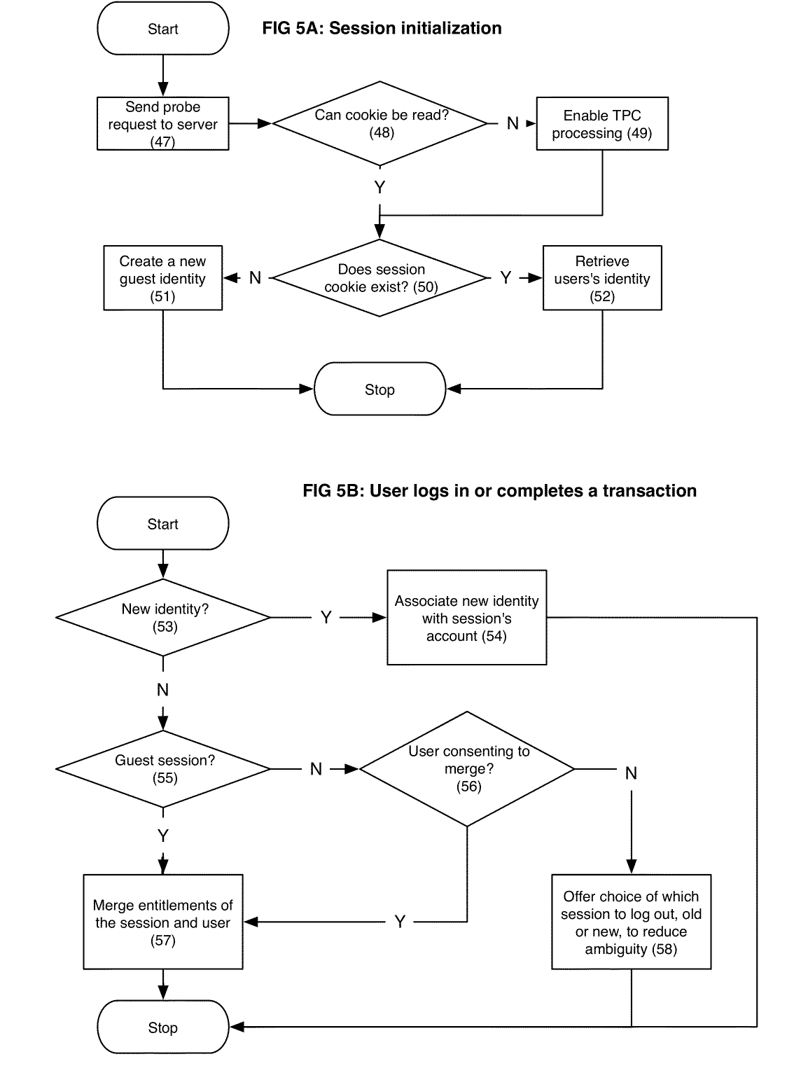

Let us now consider FIGS. 5A-5B describing the integration between the widget and the identity service 8. Whenever the widget loads, it tries to establish a session with the identity service 8—enabling it to reveal entitlements belonging to the buyer. Because an embodiment of our system operates in an iframe, we have solved the problem arising with browsers that block third-party cookies, or with buyers who block them because they are used by advertisers for tracking. Moreover, we avoid inconveniencing a prospective buyer with a registration.

FIG. 5A shows the flow whereby the widget invites the server to read the session cookie 47. If the cookie couldn't be read in 48, the widget knows that special handling will be required 49 (and it's described in more detail later in FIG. 7). Afterwards, in 50 the server inquires about the cookie in the browser. If there is no cookie, the server generates a fresh guest account for the visitor depositing the session cookie 51. On the other hand, if the buyer is already logged in, the existing session cookie is used to retrieve the state of the widget 52.

When a buyer is logged in, we refer to this as a “session”—it means the account that's currently active. On the other hand an “identity” is a combination of a name and password, or a federated identity. There is usually only one active session, but there can be multiple identities associated with it. A guest session is a session without a known identity. Typically, an identity is associated only with one account. There can be several sessions associated with a single account, especially when using multiple devices or multiple browsers.

FIG. 5B describes how our system handles a situation where a buyer logs in with an account with a session already in place. It must be noted that performing a payment can be an act of logging in when the payment mechanisms yield the identity of the payee to the payment service 10. If the identity that's yielded is not a part of any accounts 53 then it is simple to associate it with the account belonging to the currently active session 54. If we do have an existing identity, we check if the session is a simple guest one, without any identities 55. If so, it is very simple to attach the session's account to an existing account by merging their entitlements 57. If not, we need to get consent from the buyer 56 as there are situations where, for example, a mother would perform a payment for her son, but would not want him to access all the her entitlements. Therefore, the choice of which identity or identities to detach from the session is offered to the buyer in 58. In our example, the mother would detach hers from her son's session. A simplified implementation of a part of the above logic which retrieves the yet unknown email address from a payment transaction and links it to a buyer account is:

def transaction_details_for(payment)

| result = AMAZON_FPS.get_transaction( | |
|---|---|
| | Remit::GetTransaction::Request.new( :transaction_id => payment.transaction_id ) ) |
| create_amazon_request( :transaction_details, Hash.from_xml(result.raw), payment ) | |
| { | :status => result.transaction.status_code, :fee => result.transaction.fees.value, |

:buyer_name => result.transaction.sender_name, :buyer_email => result.transaction.sender_email

}
end
def add_email_from_external_source(address, source, validated=false)

return if address.blank?
if ea = email_addresses.find_by_address(address)

if !ea.validated? && validated

ea.mark_validated!(ea.validation_code)

end

else

transaction do

cleartext_password = nil
if ( sso_identifiers.scoped.empty? ||

(sso_identifiers.scoped.count == 1 && SsoIdentifier::SERVICES.include?(source))

```
  ) &&
  email_addresses.scoped.empty? &&
  crypted_password.blank? && password.blank?
cleartext_password = populate_password
meta(:email_address_which_received_generated_password, address)
```

end unless role?(:orchard)
ea = email_addresses.build( :address => address, :source => source,

:validated => validated )

ea.should_not_send_validation_email = validated || cleartext_password
unless ea.save

reload
raise ActiveRecord::Rollback, “email was not persisted (not valid?)”

end
ea.send_welcome_email(cleartext_password) if cleartext_password
ea

end

end

end
def add_name_from_external_source(new_name, source)

if name.blank?

update_attribute(:name, new_name)
meta(:external_source_name, source)

end

end

The process of merging 57 is governed with the criterion that nothing should be lost in the process. For example, if either of the two accounts owns an entitlement, the entitlement should be retained. If either of the two accounts have an item in a cart, the item should be retained. The exact rules are simple to infer. It can happen that there are duplicate or conflicting transactions, and in such cases we can issue refunds.

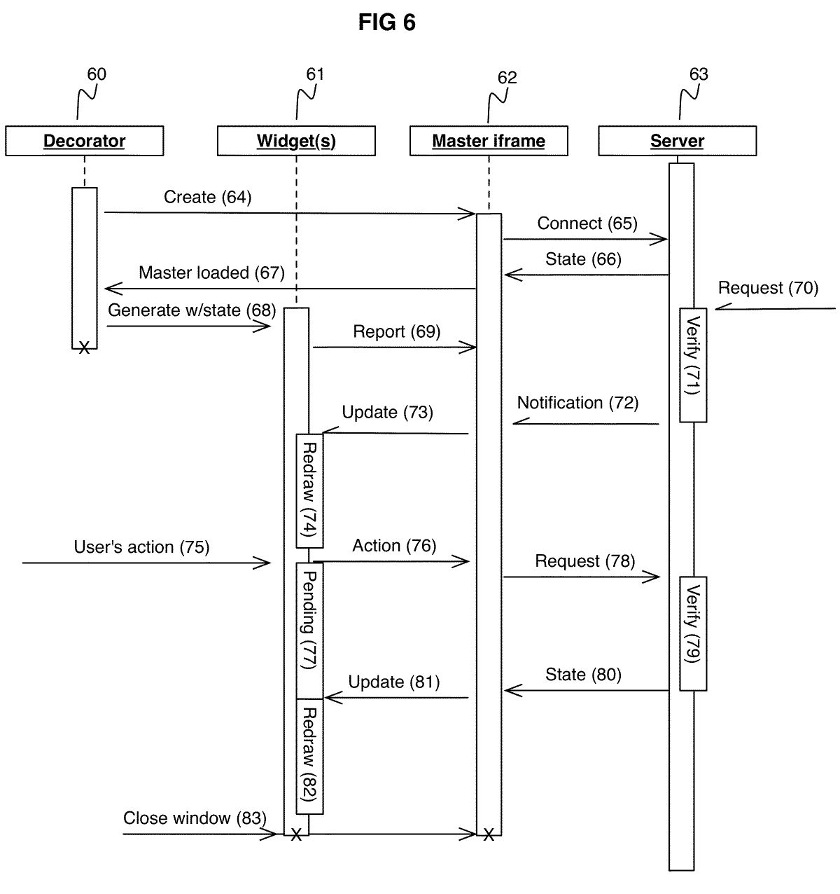

In FIG. 6 we describe one embodiment of how a number of widgets efficiently operate on a page, and how they dynamically synchronize with one another, communicate with the system's trusted server (thus bypassing the untrusted server) and display their states. There are several processes: the decorator 60 coordinates the construction of the structure, first creating a master iframe 62 and successively one or several widgets 61. This ensures that there is only one master iframe, which coordinates communication between widgets and the server 63.

Each embeddable element is enclosed within a <script> tag in one embodiment. For example, a widget is encoded as a script embedded inside a web page loaded from a trusted server:

<script
src=“https://ganxy.com/g.js#eyJwcmljZSI6IiQwLjUwIiwicm9sZSI6InRyYWNrIiw
iaWQiOjIwLCJkZXNjcmlwdGlvbiI6IlNlcmlvdXNseSIsInByZXZpZXciOlsiaHR0cHM6Ly
9zMy5hbWF6b25hd3MuY29tL2dhbnh5LXNhbXBsZXMvMzAwL3NhbXBsZS5tcDMiXSwiZGFya
yI6dHJ1ZX0%3D”></script>

The script contains encrypted information about the product, its price and the owner of rights to it so that an untrusted website or webmaster can't easily mislead buyers about the product.

The scripts generate a single decorator that traverses the DOM of the page looking for widgets to instantiate. The decorator then creates the master iframe 64 within an <iframe> tag. The master iframe performs the connection to the server 65, parts of which have been described in FIG. 5, and obtains the states for registered widgets 66, and communicates them to the decorator 67. Afterwards, the decorator generates individual widgets 68 with the state that's been obtained from the master iframe in 67. Each widget reports to the master iframe 69, and the master iframe will inform it when notifications arrive. Here is an example of how the code for multiple elements looks:

<div class=“ganxy-bundle”>

<div class=“ganxy-bundle-header”>

<script

src=“https://ganxy.com/g.js#eyJpZCI6MzAsInByaWNlIjoiJDQuMDAiLCJkZXNjcml
wdGlvbiI6Ik9uZSBZZWFyIiwicm9sZSI6ImJ1bmRsZSJ9”></script>

</div>
<ol class=“ganxy-bundle-tracks”>

<li>

<script

src=“https://ganxy.com/g.js#eyJpZCI6MjAsInByaWNlIjoiJDAuNTAiLCJkZXNjcml
wdGlvbiI6IlNlcmlvdXNseSIsInJvbGUiOiJ0cmFjayIsInByZXZpZXciOlsiaHR0cHM6Ly
9nYW54eS1zYW1wbGVzLnMzLmFtYXpvbmF3cy5jb20vMzAwL29yaWdpbmFsL3NhbXBsZS5tc
DMiXX0%3D”></script>

</li>
<li>

<script

src=“https://ganxy.com/g.js#eyJpZCI6MjEsInByaWNlIjoiJDAuNTAiLCJkZXNjcml
wdGlvbiI6IlNub3cgQW5nZWwiLCJyb2xlIjoidHJhY2siLCJwcmV2aWV3IjpbImh0dHBzOi
8vZ2FueHktc2FtcGxlcy5zMy5hbWF6b25hd3MuY29tLzMwMS9vcmlnaW5hbC9zYW1wbGUub
XAzIl19”></script>

</li>

</ol>

</div>

The bundle-header is a regular widget that allows purchase of the complete music album. The master iframe 64 which coordinates the communication with the trusted server is created by the g.js script, only once per page, regardless of the number of widgets/bundles present on that page.

Requests for entitlement changes arrive to the entitlement service from other pages, other widgets or even the checkout pages 70. In the present embodiment, the entitlement service verifies them 71 ensuring a coherent state, and notifies master iframes 72 subscribed to the items about changes. The master iframe then passes state changes to widgets, updating them 73. Widgets redraw themselves 74.

When the buyer performs an action that affects the server within a widget 75, such as a click on “buy”, the widget passes the action to the master iframe 76, and puts itself in a pending state 77, so the buyer knows that his request has been received but needs to be synchronized with the server. The master iframe further communicates the request to the server 78, leading to verification 79. The updated state is passed by the server 80 and then through the master iframe 81 to the widget that can now terminate the “pending” state and initiate a redraw 82. As a part of this, the widget receives codes for further state transitions.

In some embodiments, the widget can also receive instructions on the expected outcome of an action, so that the widget can be placed into a new state immediately after click. This increases the complexity of communication, but makes the interface quicker to respond.

When the browser window is closed 83, the widgets shut down and the master iframe loses its connection to the server.

FIGS. 7A-7B describe the communication between the master iframe and the server when an action needs to be communicated from the widget to the server. In step 93 of FIG. 7A, the master iframe checks the outcome of process 49 regarding whether the third-party cookies are blocked. If not, a simple request can be made directly from the master iframe 94. If yes, a popup operating from the server 4's domain is required but it's not clear if the popup is still active 95. If it's active, the request is passed to the server through the popup 98. If not, delegates are set up that allow the popup to take over the responsibilities from the master iframe and the widgets 96.

Moreover, the popup is opened and the popup establishes a connection with the server 97.

FIG. 7B illustrates the sequence diagram showing the receipt of a notification from the server 100 through the popup to the master iframe 101. After it's received by the master iframe, it selects an appropriate action handler 102, but does not execute it itself (as the wrong cookie would be sent to the server). Instead, a delegate that will perform the action is passed to the popup 103. After the popup receives the request 104, the popup executes the ‘GET’ action on the server through the delegate 105. As usual, the server performs verification and sends the state back to the popup 106 and the popup then informs the master iframe about the new state 107.

The popup itself is visible and offers information and some direct controls that are slightly more responsive than those on the widgets on the page. An example embodiment is illustrated in FIG. 7C.

A practical implementation of the system starts with the rights-holder of the content—or provider—registering the content or services with the system. Typically, the content is uploaded to the server. The server application stores the content and generates a preview of the content. This preview allows a buyer to quickly review the content before purchase. The provider configures the description and the price of the content. Afterward, the provider can generate different forms of widgets, which can be inserted into a web page. The system also offers sales and visit analytics and other features. As buyers make purchases, the system accumulates the provider's royalties. The provider can choose when to transfer the available royalties to his own bank account, but carries the fees associated with the transfer.

### Advantages

From the description above, a number of advantages of some embodiments of our electronic commerce system become evident:
a) Integrating widgets into a website requires no programming. Widgets can then be integrated into any website, even an untrusted one. Websites are standardized and inexpensive for providers to set up. Buyers require no special software or hardware to access them.
b) Widgets offer a buyer a standard trusted interface to preview content and safely purchase it. The purchasing process is highly streamlined and adapted even for a first-time buyer. The checkout process does not require the buyer to enter personal information, as most payment systems yield the email address.
c) The content is delivered only to an authenticated and authorized buyer. This allows a higher degree of protection against unauthorized duplication—as the buyers would have to share their private credentials for their email, social network, or other accounts with others to effectively share the purchases.
d) Our system keeps purchases associated with any of the authentications, allowing the buyer to add a more convenient federated authentication option after the purchase has been initially linked to his email address. As an extra benefit, a single transaction can be used for content from multiple providers.
e) The widgets maintain their state and can allow the buyers to access the content or services after they have been purchased.
f) All earnings are immediately transparent and available to the owner, in contrast to other retailers that pay after a fixed delay.
g) When the earnings are low, the operator of the system does not have to incur losses associated with, for example, spending more on postage for checks than the value of those checks.

### CONCLUSION, RAMIFICATIONS, AND SCOPE

Accordingly, the reader will see that our embeddable electronic commerce system allows authors and content owners to sell their content and services using their existing Internet sites, yet without having to do any manual work operating the sales. At the same time, they do not have to redirect their visitors to a separate commerce website. We have made a novel use of the iframe technology to bring trusted commerce to an otherwise untrusted website. Most computers and smartphones offer Internet browsers, so our functionality is accessible anywhere.

We have made novel use of the information associated with the payment to automate the creation of an account, eliminating the registration from the purchase flow. Our commerce interface offers purchasing functions to a shopper, but access functions to the buyer. This way, buyers can be reminded of their purchases when they visit the website of the author or content owner. As a further safety measure, the operator of the system offers access to the content to an authenticated buyer, protecting the buyer in case the author or content owner makes changes to their Internet presence. Furthermore, we provide the ability of the buyer to make changes to their identity without losing associated purchases.

Although the description above contains many specifics, these should not be construed as limiting the scope of the embodiments but as merely providing illustrations of some of the presently preferred embodiments. For example, there are several alternative ways of implementing the electronic commerce system:
a) While the preferred embodiment was implemented with a browser, the present system can also operate outside the browser with custom software. Our prototype requires no plugins, so it can operate on numerous mobile platforms.
b) Several of the features listed in this system have been developed for increasing the ease of use, speed or reliability. The system will still operate under such circumstances.
c) The widgets used in the examples of the embodiment are compact. It is possible to separate different data and buttons into separate widgets—for example separating the price from the description. This would give the designer of pages where widgets are embedded a greater degree of freedom.
d) The access control that has been implemented using a CDN can also be implemented as a thin application software layer around provider's own file servers. This comes in particularly handy when the providers have custom storage systems with large collections of data and low traffic.
e) The system does not work just for music and content, but also for software, streaming content such as video, news articles, and even services. The adaptations to access control are relatively minor.
f) The price can be adaptively set if the provider trusts the operator of the system to be sufficiently incentivized by a revenue share model. Various types of information can be utilized for determining pricing, such as the amount of hesitation before purchase.
g) It is possible to require several authentications when multiple identities are associated with an account for riskier operations. This would further secure the system.
h) If the provider has his own merchant account, they can be tied to the system's payment mechanisms. In such cases, a certain proportion of transactions are still taken over by the service operator to implement revenue sharing. It would also be possible for a provider with a strong brand to collect payments for smaller brands and earn a percentage of sales for helping execute a transaction.
i) It is possible to allow several owners of rights to the content, and the system can manage and subdivide the revenues for them. This allows agents to receive a percentage of the sales, as well as affiliates that exposed the content to traffic, and even advertisers who paid to expose the content in exchange for earning a percentage of sales.
j) It is possible for buyers to pre-purchase rights to redistribute the content with a discount.
k) It is possible for buyers to pre-purchase credits at a discount.
l) It is possible for the provider to track every sale. This would work by having the server execute a provider-specified script or a tracking cookie.
m) It is possible to allow affiliate sales with the present system, whereby the website hosting the content could earn a percentage of the sales.
n) There are various types of alternative payment systems, including watching advertisements, filling in surveys, doing work, or using virtual currencies. The risk of success can also be borne by the operator of the system.
o) It would be possible to capture the payment information of the buyer, eliminating the need for a dedicated checkout through the payment service.
p) It is possible to offer a retail credit, whereby an identified buyer can receive some of the content before being asked to pay. The identity is effectively collateral.
q) It is possible to authorize a credit card for a certain amount and then change the amount within 30 days.
r) It is possible to expose the payment processing fees to the buyer in terms of reduced discounts so that the buyer has an incentive to pick a mechanism with lower processing fees.
s) It is possible to offer simpler refunds—especially because the marginal cost of content is very low. Easy refunding allows buyers not to have to predict the value of content. If the provider carries the risk of issuing a refund, and helps bring a buyer to the point of completing a payment, they could earn a percentage for this act of customer referral. It is conceivable that a reputation management system could be developed.
t) It is possible for a service to stamp a quality rating on a piece of content and pay for refunds while earing a percentage of purchases. This would incentivize the quality estimation service to accurately predict quality, and methods of working around dishonesty can be developed.
u) It is possible to save a few clicks by offering the payment options from the widget itself. This creates no problems if the payment system allows the buyer to review the purchases, and is particularly effective for impulse buying.
v) We have developed a way for the widget to expand outside the area allocated to it by the iframe.
w) It is possible to retrieve the content in an encrypted format prior to purchasing it, so that it's ready and waiting for the buyer to receive a short key from the server, allowing almost instantaneous display. A variation of this approach for text would be based on permuting the order of sentences in a text article: this would allow search engines to successfully index the content, but not cache it in a useful way. This way, readers can find the content, but not enjoy it until it's purchased.
x) Using the email address, the system can associate the purchases with that address, sending a randomly generated password to the buyer without inconveniencing him with redundant data entry. Buyers also have the option of connecting their existing federated (OAuth, Facebook Connect, U.S. Pat. No. 7,912,762 to Sirota) or delegated authentication methods (email, OpenID, telephone verification).
y) As additional protection, the provider can configure the system to watermark the content with information identifying the buyer.
z) Another innovative feature is bundle completion. If a buyer has already purchased several pieces of a larger collection of items, the price of the collection will be reduced by the sum total of already purchased items. Assume an album composed of 10 songs for $8. If the buyer already owns two songs, each for $1, the whole album will only cost $6. If the buyer purchases 8 songs, the remaining two will be granted free of charge. This way our system allows the buyer to try smaller purchases before larger ones.

Thus the scope of the embodiments should be determined by the appended claims and their legal equivalents, rather than by the examples given.

What is claimed is:

1. A computer-implemented method for performing trusted operations on an untrusted website, comprising:
A code identifying a widget embedded in a website associated with a product and an owner of rights associated with said product;
a trusted widget script loaded from a trusted server, initiating a self-contained user interface within the application (such as browser) used to view said website;
transmitting information, content and allowed actions about said product from said trusted server to said widget, where said user interface displays said information and said actions to a user interacting with said user interface and maintains a user's identity;
taking, responding to and/or transmitting information about said user and actions of said user to said trusted server.

2. The method of claim 1, wherein said widget displays information and actions associated with commerce. Examples of said information are price, terms of purchase, product description, product photo, preview, information about a product author, reviews, related products, special offers, and similar. Examples of said actions are logging in, logging out, creating an account, addition and removal from cart, payment options, checkout, subscription options, communication with said owner or said product author and similar.

3. The method of claim 1, where identity service automatic generates a guest identity and associates it with said user's identity when no existing said user's identity is found.

4. The method of claim 1, where new trusted channels of communication are open in a separate trusted browser windows when necessary (such as in absence of third party cookies).

5. The method of claim 1, wherein said widget recognizes said user on a different website than where said user initially created an account.

6. The method of claim 1, wherein said user's identity incorporates a plurality of external identities delivered from an external service through a transaction into said user's identity.

7. The method of claim 6, wherein the logic gracefully handles overlap between said external identities between multiple said user identities each of which having purchases associated with them.

8. The method of claim 6, where said user can detach said external identity from said user identity;

9. The method of claim 1, wherein a plurality of said widgets exist on the same web page and establish an efficient communication between each other and said trusted server.

10. The method of claim 1, wherein said widget corresponding to the product is not in a single unit, but as a plurality of units, such as price unit, buy button unit, preview unit.

11. The method of claim 1, wherein said widget can change the position, location, size and other properties of any unit associated with the widget.

12. The method of claim 1, wherein said widget refers to a plurality of products and a plurality of owners of rights to said products.

13. The method of claim 1, wherein said widget operates within a plugin embedded inside said application (such as Adobe Flash embedded inside Firefox application) and not directly within said application.

14. The method of claim 1, wherein said code identifying said product and owner is encoded to protect the product and owner information from tampering.

15. The method of claim 1, where content is pre-loaded in encrypted format, and decrypted upon purchase.

16. The method of claim 1, where each said widget has a corresponding web site, referred to as a showcase.

17. The method of claim 1, where said owner can inquire about said user's said actions and status manually or automatically, and where said user can limit such inquiries.

18. A computer-implemented commerce system operated by a retail operator, comprising:
A trusted entitlement service module managing widgets and other means of sale and promotion,
a management module for items and licenses used by owners of product rights to upload their digital products, create descriptions of services and said products, generate previews and widgets;
a deductions module for said owners to monitor sales to invoice said retail operator for royalties accrued from sales, as well as monitor promotions, buyers and individual sales;
a payment service module interfacing with a plurality of payment systems and performing deductions;

19. The system of claim 18, wherein said owners of product rights can link their own merchant accounts in addition to ones offered by the said retail operator.

20. The system of claim 18, wherein said retail operator works with a plurality of owners for the same product, allocating funds between them in accordance with their contributions.
